(19) United States
(12) Patent Application Publication
(10) Pub. No.: US 2012/0169774 A1
(43) Pub. Date: Jul. 5, 2012

(54) METHOD AND APPARATUS FOR CHANGING A SIZE OF SCREEN USING MULTI-TOUCH

(75) Inventor: Ki Han YU, Gyeonggi-do (KR)

(73) Assignee: SAMSUNG ELECTRONICS CO., LTD., Gyeonggi-Do (KR)

(21) Appl. No.: 13/331,188

(22) Filed: Dec. 20, 2011

(30) Foreign Application Priority Data
Jan. 5, 2011 (KR) 10-2011-0000833

(51) Int. Cl. G06T 3/40; G06F 3/041

(52) U.S. Cl. 345/661

(57) ABSTRACT

A method for changing a screen size using a multi-touch preferably comprises: executing a contents; inputting a multi-touch signal that requests a display size change of a contents screen that executed the contents. At least one of the horizontal display size and the vertical display size of the contents screen are changed in size according to the inputted multi-touch signal, and outputting the changed contents screen.

### CLAIM OF PRIORITY

This application claims priority under 35 U.S.C. §119 from Korean Patent application No. 10-2011-0000833 filed Jan. 5, 2011, the contents of which are hereby incorporated by reference in its entirety.

### BACKGROUND OF THE INVENTION

1. Field of the Invention

The present invention relates to a method and an apparatus for changing a display size of a screen. More particularly, the present invention relates to a method and an apparatus for changing a display size of a screen using a multi-touch display.

2. Description of the Related Art

In recent years, with the significant developments in information and communication technology, and a semiconductor technology, the manufacture and use of portable terminals have rapidly increased worldwide. In particular, recent portable terminals have been developed to converge a traditional unique field such as voice communication with many different types of functionality that were often performed separately by discrete devices. As a representative example of more recent portable terminals, a mobile communication terminal now provides various functions such as a TV watching function (e.g., mobile broadcasting such as Digital Multimedia Broadcasting (DMB) or Digital Video Broadcasting (DVB)), a music playing function (e.g., MPEG Audio Layer-3 (MP3)), a photographing function, and a data communication function as well as general communication functions such as a voice call and a message transmission/reception.

The portable terminal can now freely download and use contents (a game and a movie file, or the like) faster and more easily than known before. However, the contents being received and used by the portable terminal are generally manufactured for execution at a designated resolution that often does not match the resolution of a portable communication terminal display screen. Hence, in the case where a content is downloaded and executed in the portable terminal, the contents may be displayed only on a portion of the display panel, not the entire screen because of the difference between the resolution of the portable terminal and the designated resolution of the contents. Likewise, there is a need for a method for solving the problem that a content is not always displayed on the entire display screen of the portable communication terminal due to a difference between the resolution of the portable communication terminal and a designated resolution size of the contents. Particularly, as the number of portable terminals using a touch screen increases, there is an increased need in the art for a method and an apparatus that outputs the contents on the entire screen by changing the size of the contents screen using the touch screen.

### SUMMARY OF THE INVENTION

The present invention provides a method and an apparatus for changing a displayed screen size of a display screen using multi-touch, in which the method and apparatus can easily change at least one of the horizontal size and the vertical size of a contents screen using a multi-touch.

In accordance with an exemplary aspect of the present invention, a method for changing a screen size of a portable terminal using a multi-touch preferably includes: executing a contents by a controller; inputting a multi-touch signal that requests a size change of the display of a contents screen on a device that has executed the contents; and changing at least one of the horizontal sizes or the vertical sizes of the contents screen according to the inputted multi-touch signal received, and outputting the changed contents screen.

In accordance with another exemplary aspect of the present invention, an apparatus for changing a screen size using a multi-touch preferably includes: a display panel that displays output of a contents screen that executes a contents; a touch panel that receives a multi-touch input signal that requests a size change of the contents screen; and a controller that controls change of at least one of a horizontal size and a vertical size of the contents screen according to the inputted multi-touch and outputs the changed size of the contents screen.

As described above, a method and an apparatus for changing a displayed screen size using a multi-touch according to an exemplary embodiment of the present invention can easily change (enlarge or reduce) by using a multi touch input at least one of the horizontal size and the vertical size of a screen, which is outputted on a display unit. Hence, a user can change a display size of contents which heretofore were executed only at a designated screen resolution, into a screen size the entire size of the display screen, and output the contents on the entire screen.

### BRIEF DESCRIPTION OF THE DRAWINGS

The exemplary objects, features and advantages of the present invention will become more apparent from the following detailed description in conjunction with the accompanying drawings, in which:

FIG. 1 is a block diagram illustrating one possible configuration of a portable terminal according to an exemplary embodiment of the present invention;

FIG. 2 is a flowchart illustrating exemplary operation of a method for changing a screen size using a multi-touch according to an exemplary embodiment of the present invention; and

FIGS. 3 to 5 illustrate exemplary operation of a method for changing a screen size using a multi-touch according to an exemplary embodiment of the present invention.

### DETAILED DESCRIPTION

Exemplary embodiments of the present invention are described with reference to the accompanying drawings in detail. The same reference numbers are used throughout the drawings to refer to the same or like parts. Detailed descriptions of well-known functions and structures incorporated herein may be omitted to avoid obscuring appreciation of the subject matter of the present invention by a person of ordinary skill in the art with such well-known features and structures.

The terms and words used in the following description and claims are not limited to their bibliographical meanings, but are used by the inventor to enable a clear and consistent understanding of the invention. Accordingly, it should be apparent to those skilled in the art that the following description of exemplary embodiments of the present invention are provided for illustrative purposes only and not for the purpose of limiting the invention as defined by the appended claims.

It is to be understood that the singular forms “a”, “an”, and “the” include plural references unless the context clearly dictates otherwise. Thus, for example, reference to “a component surface” typically includes reference to one or more of such surfaces.

The term “substantially” typically means that the recited characteristic, parameter, or value need not be achieved exactly, but that deviations or variations, including for example, tolerances, measurement error, measurement accuracy limitations and other factors known to skill in the art, may occur in amounts that do not preclude the effect the characteristic was intended to provide. For example substantially simultaneous multi-touch comprises a plurality of touches of a touch screen within a predetermined time frame or distance such that the controller recognizes same as a single action defined by the plurality of touches.

In the following description, a mobile communication terminal will be used as an example of a method and apparatus for changing display size of a screen using multi-touch according to the present invention, but the present invention is not limited thereto. For example, the present invention can be applied to any apparatus including a touch screen capable of recognizing a multi-touch. In other words, the present invention is applicable to many devices including but in no way limited to a tablet personal computer (tablet PC), a portable multimedia player (PMP), a navigation terminal, a smart phone, an electronic book terminal and an electronic dictionary terminal, or the like, just to name a few non-limiting examples.

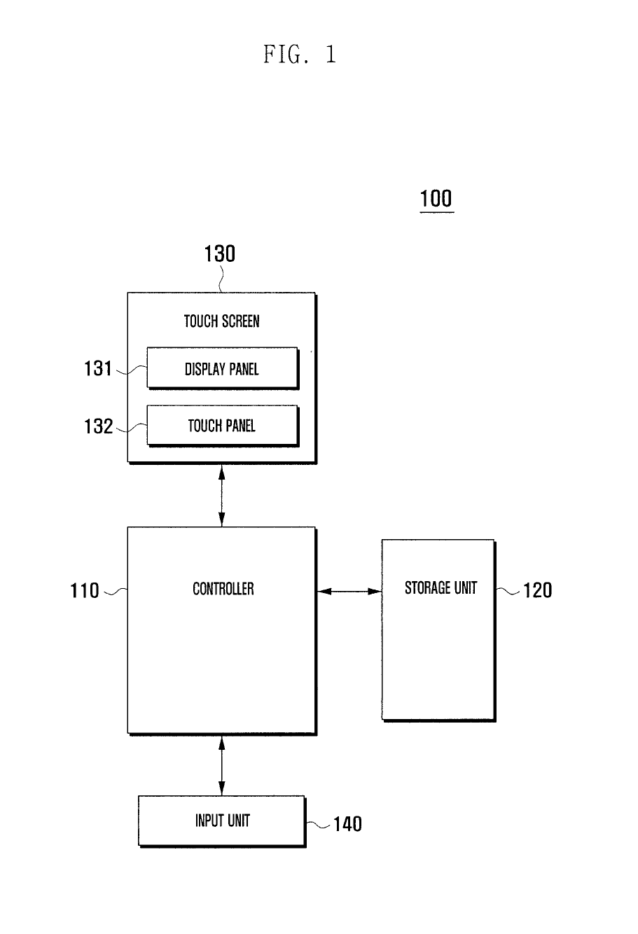

FIG. 1 illustrates a configuration of a portable terminal 100 according to an exemplary embodiment of the present invention.

Referring now to FIG. 1, the portable terminal 100 according to an exemplary embodiment of the present invention may preferably include a controller 110, a storage unit 120, a touch screen 130 and an input unit 140. The touch screen 130 may include, for example, a display panel 131 and a touch panel 132.

The portable terminal 100 having such an exemplary configuration as in FIG. 1 can change at least one of the horizontal size and the vertical size of a contents screen that executes a contents (e.g., a game and a moving picture, or the like), which is manufactured to be executed at a designated resolution resulting in a particular display size, according to a multi-touch, and output the size-changed contents display screen. In other words, in case a contents is not output on the entire screen of the display panel 131, a user can change at least one of the horizontal size and the vertical size of the contents screen so that the contents, which is displayed at the designated resolution, is outputted on the entire screen of the display panel 131. Hereinafter, each element of the configuration of the portable terminal 100 will be explained in more detail.

With continued reference to FIG. 1, the input unit 140 may include input keys and function keys for receiving an input of information of numbers or various letters, setting various functions, and controlling the functions of the portable terminal 100. For example, the input unit 140 may include a voice call key for a voice call request, a video call key for a video call request, a termination key for a voice call or video call termination request, a volume key for adjusting the output volume of audio signals, and a direction key of keys, or the like. Particularly, the input unit 140 according to the present invention may include a function key (hereinafter, called “restoration key”) which restores the screen size of the size-changed screen into the original size. A separate key may be used for the restoration key, or one of the existing keys can be changed to include the restoration key function. For example, when a content is executed, a home key can be set so that the key can also be operated as the restoration key. Such an input unit 140 can be formed by one or a combination of input components such as a touchpad, a touch screen, a button-type key pad, a joystick, and a wheel key, or the like.

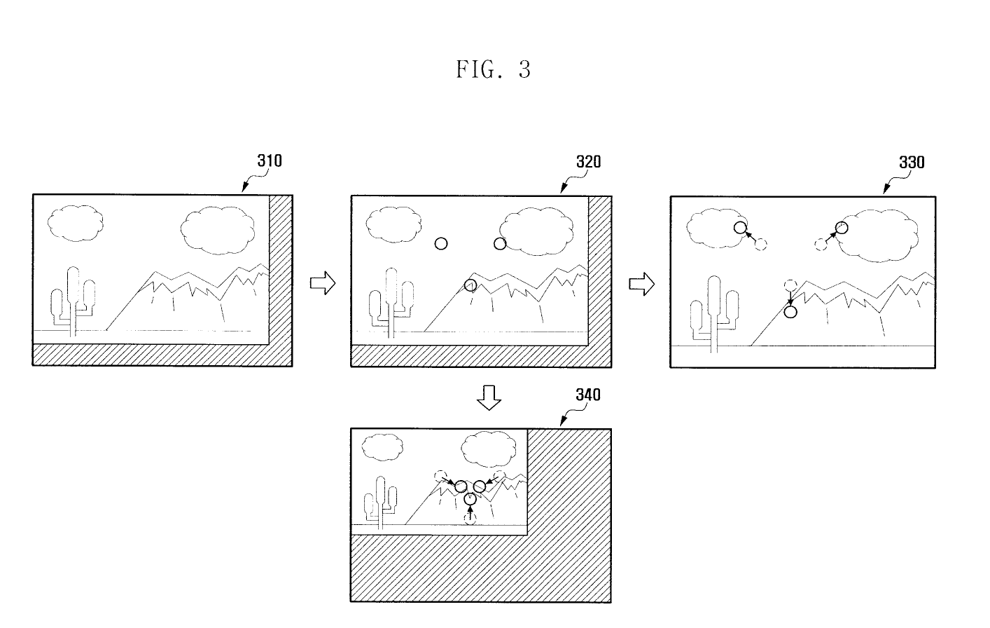

The touch screen 130 can perform a screen output function and a touch input function. To this end, the touch screen 130 may include a display panel 131 and a touch panel 132. The display panel 131 preferably displays information inputted by user or information to be provided to user including various menus of a portable terminal 100. For example, the display panel 131 can provide various screens according to the use of the portable terminal 100, such as an idle screen, a message-writing screen and a calling screen, or the like. More particularly, the display panel 131 according to the present invention can output contents at a designated resolution when the contents are outputted. At this time, in case the contents' designated resolution is smaller than the maximum resolution of the display panel 131, the display panel 131 can output the contents at one portion and output the remaining portion with a block color. The display panel 131 can change at least one of the horizontal size and the vertical size of the contents screen according to a multi-touch input, and output the changed display screen, through which user can adjust the screen so that the contents is outputted on the entire screen. The detailed description of the screen output will be explained later with reference to a screen example of FIG. 3. Such a display panel 131 can be formed by a liquid crystal display (LCD), an organic light emitted diode (OLED), and an active matrix organic light emitted diode (AMOLED), or any other type of think film technology screen or the like can be suitable for use with the presently invention.

The touch panel 132 is installed on the front side of the display panel 131, and can sense generation of a touch event by detecting a change in some physical quantity (e.g., resistance, capacitance, and light interception, or the like). The touch panel 132 can convert a change in physical quantity according to the touch event into a digital signal, and transmit the digital signal into the controller 110. More particularly, the touch panel 132 according to the present invention can recognize a multi-touch event. The touch panel 132 can be formed in various types such as a capacitance type, a resistance type, and an infrared type, or the like. Such a touch panel 132 is well-known to those skilled in the art, so the detailed description will be omitted here.

The storage unit 120, which comprises a non-transitory machine readable medium, can store user data, or the like, including a program that executes a function according to an exemplary embodiment of the present invention. For example, the storage unit 120 can store a program for controlling general operation of a portable terminal 100, an operating system (OS) for booting the portable terminal 100, an application program for other optional functions of the portable terminal 100, such as a camera function, a sound replay function, an image or moving picture replay function, a near field communication (NFC) function, and a multimedia contents replay function, or the like, and user data, which is generated according to the use of the portable terminal 100, such as a text message, and a downloaded contents (a game, a music video, and a movie, or the like). More particularly, the storage unit 120 according to the present invention can store a program that changes at least one of the horizontal size and the vertical size of the screen according to a multi-touch input, and outputs the contents on the size-changed screen.

The controller 110, which includes a processor or microprocessor, preferably controls general operation of the portable terminal 100 and a signal flow between internal blocks of the portable terminal 100. Particularly, the controller 110 according to the present invention can control a change of the display size of a contents screen according to a multi-touch input. Specifically, in the exemplary case where a user touches three points in a circle and stretches the touched three points, the controller 110 can increase the horizontal size and the vertical size of the contents screen. In contrast, in the case where the user touches three points and pinches the touched three points, the controller 110 can decrease the horizontal size and the vertical size of the contents screen. Further, in the case where the user touches three points in a row in a horizontal direction and moves two end points in the horizontal direction while fixing the point in the middle, the controller 110 can change the horizontal size of the contents screen. For example, in the case where the touches of the two end points are moved in a direction that travels further away from the touch in the middle, the controller 110 can increase the horizontal size of the contents screen, and in case the touches of the two end points are moved in a direction that travels closer to the touch in the middle, the controller 110 can decrease the horizontal size of the contents screen. At this time, in case the touch of one end point is moved while fixing the touch of the other end point, the controller 110 can fix the position of the vertical side corresponding to the fixed touch and change the horizontal size of the contents screen. Likewise, in case user touches three points in a row in a vertical direction and moves touches of two end points in the vertical direction while fixing the touch in the middle, the controller 110 can change the vertical size of the contents screen. The detailed description on the change of the vertical size of the contents screen is similar to the above-explained change of the horizontal size of the contents screen, and thus will be omitted here. Further, the controller 110 can restore the changed contents screen into the original size in the case that a preset restoration key (e.g., a home key) signal is inputted.

The controller 110 preferably controls a display-panel driving driver (not shown) so that data of an image projected to the display panel 131 is changed in order to change the size of the contents screen according to a multi-touch. The controller 110 can control the display-panel-driving driver (not shown) so that image data for outputting the contents screen can correspond to the display size of the contents screen changed from a previous or default value according to a multi-touch input. The display-panel-driving driver (not shown) can be included the display panel 131 or the controller 110, or can be separately prepared.

Further, although not illustrated in FIG. 1, a portable terminal 100 according to the present invention can selectively further include elements for providing additional functions, such as a camera module for photographing an image or a moving picture, a broadcast-receiving module for broadcast reception, a digital sound source replay module such as an MP3 module, a near field communication (NFC) module for near field communication, and a proximity sensor module for proximity sensing, or the like. Including some or all of the aforementioned examples, which are only a small percentage of the functionality that may be included in such mobile communication terminals, is subject to change and can be arranged in many different variations according to recent trends in convergence, so it is difficult to list all such elements here. However, the portable terminal 100 according to the present invention can further include elements of the same level as that of the above-mentioned elements.

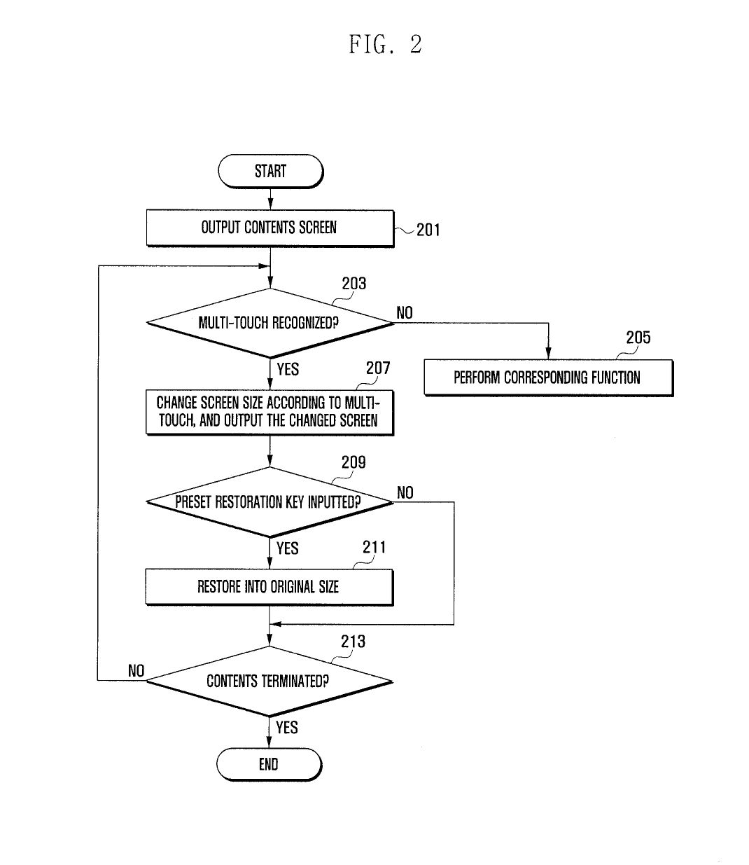

FIG. 2 is a flowchart illustrating exemplary operation of a method for changing a screen size using a multi-touch according to an exemplary embodiment of the present invention, and FIGS. 3 to 5 illustrate a method for changing a size of a displayed screen using a multi-touch according to an exemplary embodiment of the present invention.

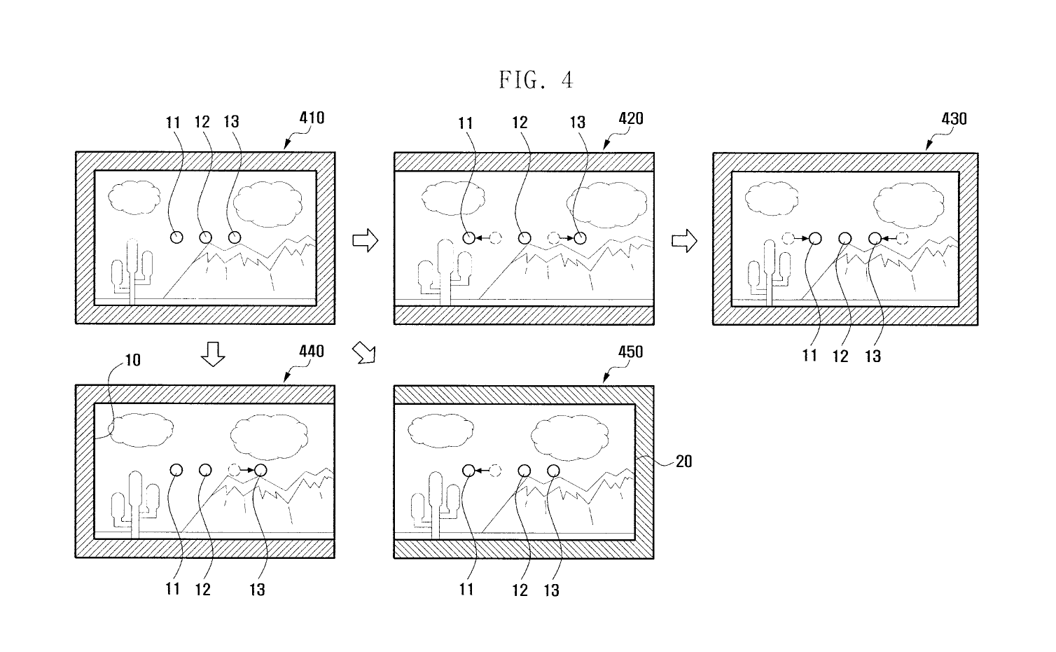

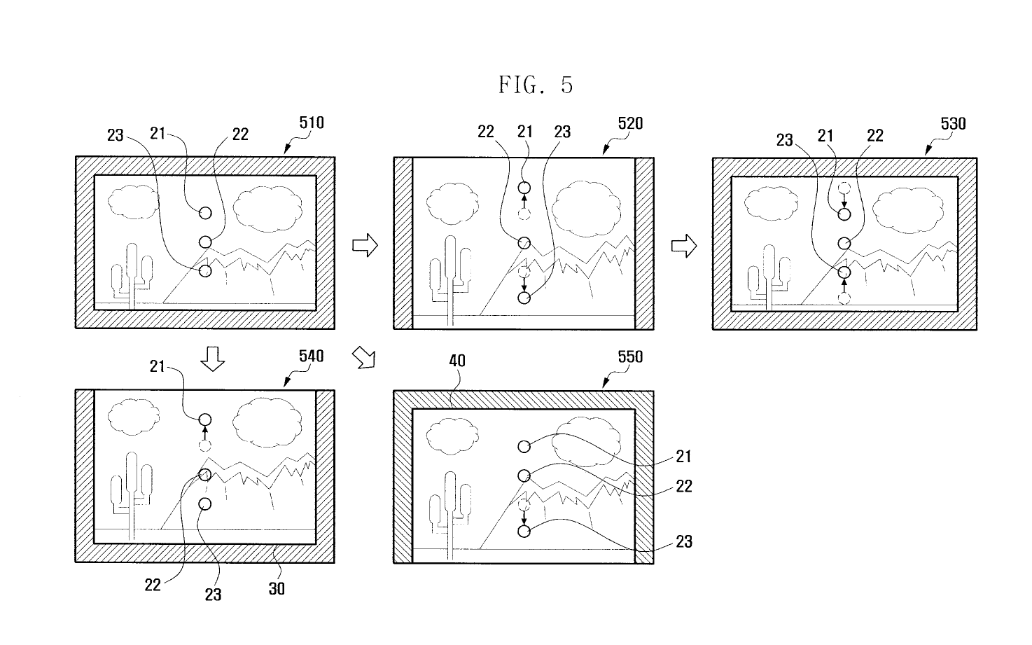

Referring now to FIGS. 1 to 5, at (201) the controller 110 can output a screen where a contents, which was manufactured at a designated resolution, is executed (hereinafter, called “contents screen”). The contents may be a game and a moving picture, or the like. At this time, as the contents is executed at the designated resolution, the contents screen may not be displayed on the entire screen of the display panel 131. For example, the contents screen can be outputted as illustrated in a screen example of reference numeral 310 of FIG. 3, a screen example of reference numeral 410 of FIG. 4, or a screen example of reference numeral 510 of FIG. 5.

At (203), the controller 110 can check whether a multi-touch is recognized. In the case where the multi-touch is not recognized, then at (205) the controller can perform a corresponding function. For example, in the case where the contents comprise a game, the controller 110 can perform a game start and a game environment setting, or the like.

In contrast, when at (203) the multi-touch is recognized, then at (207) the controller 110 can change at least one of the horizontal size and the vertical size of the contents screen according to the multi-touch, and output the changed contents screen. More specifically, as illustrated in screen examples of reference numerals 320 and 330 of FIG. 3, in the case where the user touches three points and stretches the touched three points, the controller 110 can increase the horizontal size and the vertical size of the contents screen. In contrast, as illustrated in screen examples of reference numerals 320 and 340 of FIG. 3, in the case where the user touches three points and “pinches” the touched three points, the controller 110 can decrease the horizontal size and the vertical size of the contents screen.

Further, in the case where the user touches three points horizontally in a row and moves the touches of two end points in a horizontal direction while fixing (i.e. keeping) the touch in the middle, the controller 110 can change the horizontal size of the contents screen. For example, as illustrated in screen examples of reference numerals 410 and 420 of FIG. 4, in the exemplary case where the touch points 11 and 13 of two end points are moved in a direction that gets farther from the touch point 12 in the middle, the controller 110 can increase the displayed horizontal size of the contents screen.

In contrast to the example in the above paragraph, as illustrated in a screen example of reference numeral 430 of FIG. 4, in the case where the touch points 11 and 13 of two end points are moved in a direction that bring them closer to the touch point 12 in the middle, the controller 110 can decrease the horizontal display size of the contents screen. Further, as illustrated in the screen shot example 440 of FIG. 4, in the case where only the touch point 13 on the right side among touch points 11 and 13 of two end points is moved in a right direction while fixing the touch 11 on the left side, the controller 110 can fix the position of the left vertical side 10 of the screen and increase the horizontal display size of the contents screen.

However, as illustrated a screen example of reference numeral 450 of FIG. 4, in the case where only the touch point 11 on the left side among the touch points 11 and 13 of two end touch points is moved in a left direction while fixing the touch point 13 on the right side, the controller 110 can fix the position of the right vertical side 20 of the screen and increase the horizontal display size of the contents screen.

Further, as in the above-described horizontal size change of a contents screen, in the case where the user touches three points vertically in a row and moves the touches of two end points in a vertical direction while fixing the touch point in the middle, the controller 110 can change the vertical display size of the contents screen.

For example, as illustrated in screen examples of reference numerals 510 and 520 of FIG. 5, in the case where the touch points 21 and 23 of the two end points are moved in a direction that gets farther from the touch point 22 in the middle, the controller 110 can increase the vertical size of the contents size, and as illustrated in a screen example of reference numeral 530, in the case where the touch points 21 and 23 of two end points are moved in a direction that gets closer to the touch point 22 in the middle, the controller 110 can decrease the vertical size of the contents screen.

Further, as illustrated in a screen example of reference numeral 540 of FIG. 5, in the case where only the upper touch point 21 among two end touch points 21 and 23 is moved to the upper side while fixing the lower touch point 23, the controller 110 can fix the position of the lower horizontal side 30 of the screen and increase the vertical display size of the contents screen. In contrast, as illustrated in a screen example of reference numeral 550 of FIG. 5, in case only the lower touch 23 among two end touches 21 and 23 is moved in a lower direction while foxing the upper touch 21, the controller 110 can fix the position of the upper horizontal side 40 and increase the vertical display size of the contents screen. At this time, the controller 110 can control a display-panel-driving driver (not shown) to convert data of images projected to the display panel 131 in order to change the size of the contents screen according to a multi-touch. In other words, the display-panel-driving driver (not shown) can change image data for the contents screen output so that the image data can correspond to the changed screen size according to the multi-touch input under the control of the controller 110.

With reference again to FIG. 2, at (209) the controller 110 can check whether a preset restoration key (e.g., a home key) signal is inputted. In the case where the restoration key signal is not inputted, then at (213) the controller 110 will determine whether the contents are terminated, as described hereinafter. The controller 110 can check whether the contents are terminated (213). In case the contents are terminated, the controller 110 can return to an idle screen.

In contrast, in the case where the restoration key signal is inputted, at (211) the controller 110 can restore the changed contents screen into the original display size. In case the contents are not terminated, the controller 110 can return to step 203 to repeat the above-described process. According to the examples of above-described present invention, in the case where a contents screen is not outputted on the entire screen of a display panel due to a pre-designated resolution, the size of the contents screen can be easily changed so that the contents screen can be outputted on the entire screen using a multi-touch.

The foregoing method for changing a screen size using a multi-touch of the present invention may be implemented in an executable program command form by various computer means and be recorded in a computer readable recording medium. In this case, the computer readable recording medium may include a program command, a data file, and a data structure individually or a combination thereof. In the meantime, the program command recorded in a recording medium may be specially designed or configured for the present invention or be known to a person having ordinary skill in a computer software field to be used.

The computer readable recording medium includes Magnetic

Media such as hard disk, floppy disk, or magnetic tape, Optical Media such as Compact Disc Read Only Memory (CD-ROM) or Digital Versatile Disc (DVD), Magneto-Optical Media such as floptical disk, and a hardware device such as ROM. RAM, flash memory storing and executing program commands. Further, the program command includes a machine language code created by a complier and a high-level language code executable by a computer using an interpreter. The foregoing hardware device may be configured to be operated as at least one software module to perform an operation of the present invention.

The above-described methods according to the present invention can be implemented in hardware, firmware or as software or computer code that can be stored in a recording medium such as a CD ROM, an RAM, a floppy disk, a hard disk, or a magneto-optical disk or computer code downloaded over a network originally stored on a remote recording medium or a non-transitory machine readable medium and to be stored on a local recording medium, so that the methods described herein can be rendered in such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

Although exemplary embodiments of the present invention have been described in detail hereinabove, it should be clearly understood that many variations and modifications of the basic inventive concepts herein taught which may appear to those skilled in the present art will still fall within the spirit and scope of the present invention, as defined in the appended claims. It is within the spirit of the invention and the scope of the appended claims that gesture recognition can be utilized, wherein one can, for example, make the pinch or expand gesture and the mobile communication terminal can change the size of the displayed content in accordance therewith. A camera can capture the gesture and match with a pattern from a template database, for example.

What is claimed is:

1. A method for changing a screen display size using a multi-touch, the method comprising:
executing a contents by a controller and outputting the contents to a display;
receiving by a touch screen a multi-touch input signal that requests a display size change of a contents screen that executed the contents; and
changing by the controller the display size of at least one of a horizontal display size and a vertical display size of the contents screen being displayed according to the inputted multi-touch signal, and outputting signal to the display to change the size of contents screen being displayed.

2. The method according to claim 1, wherein the controller only changes the horizontal display size of the content screen being displayed in response to the received multi-touch input signal.

3. The method according to claim 1, where the controller only changes the vertical display size of the content screen being displayed in response to the received multi-touch input signal.

4. The method of claim 1, wherein the received multi-touch input signal comprises a predetermined plurality of touch points.

5. The method of claim 1, wherein the received multi-touch input signal comprises touches three points substantially simultaneously.

6. The method of claim 1, where in the received multi-touch input signal is a captured gesture that is matched by the controller with a gesture in a template database.

7. The method of claim 4, wherein changing at least one of the horizontal display size and the vertical display size of the contents screen comprises:
increasing the horizontal display size and the vertical size of the contents screen at the same time in response to detecting by the display three touch points in a circle and a distance between the three touch points being increased by stretching a distance between three fingers;
increasing the horizontal display size of the contents screen when detecting a user touching three horizontal touch points in a row, and detects movement of two end touch points of the three horizontal touch points in a horizontal direction away from a middle touch point of the horizontal row; and
increasing the vertical display size of the contents screen when detecting a user touching three vertical touch points in a column, and detecting movement of two end points of the three vertical touch points moving in a vertical direction further from the touch point in the middle of the column.

8. The method of claim 4, wherein changing at least one of the horizontal display size and the vertical display size of the contents screen comprises:
decreasing the horizontal display size and the vertical display size of the contents screen at the same time when detecting touches of three points in a circle, and pinching the three touch points toward each other;
decreasing the horizontal display size of the contents screen when detecting touches of three points horizontally in a row, and detecting movement of the touches of two end points in a horizontal direction toward the touch point in the middle of the horizontal row; and
decreasing the vertical display size of the contents screen when detecting touches of three points vertically in a column, and detecting movement of the touches of two end points in a vertical direction toward the touch point in the column.

9. The method of claim 4, wherein changing at least one of the horizontal display size and the vertical display size of the contents screen comprises:
increasing the screen size by detecting movement of only one corresponding side from among a plurality of sides of the contents screen when detecting one of the touch points of two end points is moved in a direction away from the touch in the middle while touching three points in a row; and
decreasing the screen display size by detecting movement of only one corresponding side from among a plurality of sides of the contents screen when detecting one of the touches of two end points is moved in a direction closer to the touch in the middle while touching three points in a row.

10. The method of claim 1, further comprising:
restoring by the control the changed contents screen into the original size when detecting input of a preset restoration key signal.

11. The method of claim 1, wherein changing at least one of the horizontal display size and the vertical display size of the contents screen comprises:
converting image data for the contents screen output to correspond to a display size of the changed contents screen according to a multi-touch input.

12. An apparatus for changing a screen size using a multi-touch, the apparatus comprising:
a display panel that receives and outputs a contents screen that displays a contents;
a touch panel that generates a multi-touch input signal based on detected touch to request a display size change of the contents screen; and
a controller that controls change of at least one of the horizontal display size and the vertical display size of the contents screen according to the inputted multi-touch and outputs the changed contents screen.

13. The apparatus of claim 12, wherein the multi-touch detected by the touch panel touches comprises detecting touch of a plurality of points at substantially a same time.

14. The apparatus of claim 13, wherein the multi-touch detected by the touch panel comprises detecting touch of three points at substantially the same time.

15. The apparatus of claim 13, wherein the controller increases the horizontal display size and the vertical display size of the contents screen at the same time when the controller detects touching of three points in a circle, and detects stretching of the touches of the three points in a direction away from each other; and increases the horizontal display size of the contents screen when the controller detects touching of three points horizontally in a row, and detects movement of the touches of two end points in a horizontal direction further away from the middle of the row while fixing the touch in the middle; and increases the vertical display size of the contents screen when the controller detects touching of three points vertically in a column, and detects movement of the touches of two end points in a vertical direction is away from the touch in the middle while fixing the touch in the middle.

16. The apparatus of claim 13, wherein the controller decreases the horizontal display size and the vertical display size of the contents screen at the same time when the controller detects touching of three points in a circle, and detects pinching of the touches of the three points; the controller decreases the horizontal display size of the contents screen when the controller detects touching of three points horizontally in a row, and detects movement of the touches of two end points in a horizontal direction closer to the touch point in the middle while fixing the touch in the middle; and the controller decreases the vertical display size of the contents screen when the controller detects touching of three points vertically in a column, and detects movement of the touches of two end points in a vertical direction closer to the touch in the middle while fixing the touch in the middle.

17. The apparatus of claim 13, wherein the controller changes the screen display size by moving display of only a side corresponding to a touch movement from among all sides of the contents screen when detecting movement of one of the touches of two end points while touching three points in a row.

18. The apparatus of claim 12, further comprising:
an input unit comprising a restoration key that restores the changed contents screen to the original size for display.

19. The apparatus of claim 12, further comprising:
a display-panel-driving driver that converts image data for the contents screen to correspond to a size of the changed contents screen according to a multi-touch input.
